(19) United States
(12) Patent Application Publication
(10) Pub. No.: US 2015/0114494 A1
(43) Pub. Date: Apr. 30, 2015

(54) RECIRCULATION BLOCK

(71) Applicant: Millennium Custom Coatings, Inc., Indianapolis, IN (US)

(72) Inventor: Robert G. Crawford, Brownsburg, IN (US)

(21) Appl. No.: 14/527,838

(22) Filed: Oct. 30, 2014

Related U.S. Application Data
(60) Provisional application No. 61/898,163, filed on Oct. 31, 2013.

(51) Int. Cl. B05B 12/14

(52) U.S. Cl. CPC B05B 12/1418
USPC 137/563

(57) ABSTRACT

A recirculation block includes a top face and a bottom face that are connected by a right side face, a left side face, a front face, and a rear face. The recirculation block further includes a pair of junction block entry ports and a pair of side block entry ports. Both of the junction block entry ports are positioned on the bottom face. The first side block entry port is positioned on the right side face and the second side block entry port is positioned on the left side face. The recirculation block further includes a pair of exit ports. The first exit port is in fluid communication with both the first junction block entry port and the first side block entry port. The second exit port is in fluid communication with both the second junction block entry port and the second side block entry port.

### REFERENCE TO RELATED APPLICATION

This application claims priority to U.S. Provisional Patent Application Ser. No. 61/898,163, entitled “Recirculation Block,” filed Oct. 31, 2013, the disclosure of which is incorporated by reference herein.

### BACKGROUND

Plural component materials are typically applied using a spray system. Typical examples of plural components include but are not limited to epoxies, paints, urethane- and polyurea-based coatings, and urethane-based pour and spray foams. Plural component materials typically include a first fluid component and a second fluid component. By way of example only, the first fluid component and the second fluid component may respectively comprise a resin and a hardener, a resin and an activator, or an amine and an isocyanate.

As shown in FIGS. 1-3, a conventional spray system, such as spray systems 10 and 10′, typically includes a pair of storage tanks 20a and 20b, a proportioner 30, and a spray gun 40 that includes a spray gun manifold 50. As shown in FIGS. 1-3, each of the pair of storage tanks 20a, 20b is connected to the proportioner 30 via a respective one of a pair of proportioner supply lines 22a, 22b that allow the fluid components to flow separately from the respective storage tank 20a, 20b to the proportioner 30. Each storage tank 20a, 20b also includes a feed pump 26a, 26b configured to pump the fluid components from their respective storage tank 20a, 20b to the proportioner 30 through the corresponding proportioner supply line 22a, 22b. In addition, in the illustrated systems 10, 10′, the proportioner 30 is connected to the spray gun 40 via the spray gun manifold 50 with a heated hose 60, which allows the fluid components to flow separately from the proportioner 30 through the spray gun manifold 50 and, ultimately, to the spray gun 40, where the individual fluid components are mixed in an inner mixing chamber in the spray gun and delivered through the nozzle of the spray gun 40. The heated hose 60 typically comprises a pair of heated gun supply hoses 62a, 62b connected to a corresponding pair of heated whip hoses 64a, 64b via a fluid temperature sensor 66. As shown in FIGS. 2 and 3, the fluid temperature sensor 66 and adjacent sections of heated gun supply hoses 62a, 62b and heated whip hoses 64a, 64b are exposed for illustration purposes. The fluid temperature sensor 66 and adjacent hoses are typically wrapped in thermal tape during normal operation of spray system 10, 10′. The illustrated spray systems 10 and 10′ also include a gun air supply hose 51 configured to supply pressurized air from the proportioner 30 to the spray gun 50.

Spray system 10 shown in FIGS. 1 and 2 also includes a pair of circulation lines 24a, 24b between the proportioner 30 and a respective storage tank 20a, 20b. The proportioner 30 includes an operational setting configured to separately circulate the fluid components through the proportioner 30 and back into their respective storage tank 20a, 20b. While such an operational setting is active, the fluid components flow separately through the respective fluid supply line 22a, 22b, continue through the proportioner 30 and return to their respective storage tanks 20a, 20b via the circulation lines 24a, 24b. Spray system 10′ shown in FIG. 3 is identical to spray system 10 shown in FIGS. 1 and 2, except that spray system 10′ does not include circulation lines 24a, 24b. In other words, spray system 10 represents a typical spray system with circulation, while spray system 10′ represents a typical spray system without circulation.

FIGS. 4-8 depict two types of conventional spray guns 140, 240 and their corresponding spray gun manifolds 150, 250. Spray gun 40 and spray gun manifold 50 shown in FIGS. 1-3 may comprise any type of suitable spray gun and spray gun manifold. For example, spray gun 50 may comprise a spray gun configured to work in conjunction with a spray gun manifold comprising a single junction block, such as junction block spray gun 140 and junction block spray gun manifold 150 shown in FIGS. 4-5. One commercial example of this type of junction block spray gun is the Fusion Air Purge spray gun made by Graco Inc. Junction block spray gun 140 includes an air hose coupling 157 configured to allow a user to attach an air hose, such as gun air supply hose 51, to the junction block spray gun 140 in order to provide pressurized air to the junction block spray gun 140. In another example, spray gun 50 may comprise a spray gun configured to work in conjunction with a spray gun manifold comprising two individual side blocks, such as side block spray gun 240 and side block spray gun manifold 250 shown in FIGS. 6-8.

As shown, the junction block spray gun manifold 150 comprises a single junction block 152 that includes a first hose coupling 154a and a second hose coupling 154b. In FIG. 5, whip hose 64a is connected to first hose coupling 154a and whip hose 64b is connected to second hose coupling 154b. Junction block 152 also includes a first manifold valve 156a associated with the first hose coupling 154a and a second manifold valve 156b associated with second hose coupling 154b. First manifold valve 156a may be configured to selectively open and close to either allow the respective fluid component to flow from whip hose 64a through junction block 152 and into the inner mixing chamber of junction block spray gun 140 or prevent delivery of the fluid component into the inner mixing chamber of junction block spray gun 140. Similarly, second manifold valve 156b may be configured to selectively open and close to either allow the respective fluid component to flow from whip hose 64b through junction block 152 and into the inner mixing chamber of the junction block spray gun 140 or prevent delivery of the fluid component into the inner mixing chamber of the junction block spray gun 140.

In this embodiment, first hose coupling 154a comprises a female coupling 155a configured to receive a corresponding male coupling 65a on the end of one of the pair of whip hoses 64a, 64b. Similarly, second hose coupling 154b comprises a female coupling 155b configured to receive a corresponding male coupling 65b on the end of the other one of the pair of whip hoses 64a, 64b. As shown in FIG. 5, junction block 152 further comprises a pair of gun couplings 158a, 158b configured to connect junction block 152 to the junction block spray gun 140 and provide communication between the junction block spray gun manifold 150 and the inner mixing chamber of the junction block spray gun 140. Each gun coupling 158a, 158b may have a smooth metal finish and a fluid port that is centered within the respective gun coupling 158a, 158b. The fluid port in junction block spray gun 140 that each gun coupling 158a, 158b is connected to may include an o-ring to provide an adequate seal between junction block 152 and junction block spray gun 140. The junction block 152 may be attached to the junction block spray gun 140 using any suitable fastener 160, including but not limited to a conventional fastener, such as the pin shown in FIG. 5, or any other fastening means or method that provides an adequate connection between the junction block 152 and the junction block spray gun 140.

FIGS. 6-8 depict an alternate type of spray gun and gun manifold. Specifically, as shown in FIGS. 6-8, side block spray gun 240 is configured to work in conjunction with a side block spray gun manifold 250 comprising two individual side blocks 252a, 252b. One commercial example of this type of side block spray gun is the Probler P2 spray gun made by Graco Inc. Side block spray gun 240 includes an air hose coupling 257 configured to allow a user to attach an air hose, such as gun air supply hose 51, to the side block spray gun 240 in order to provide pressurized air to the side block spray gun 240.

In the illustrated embodiment, the side blocks 252a, 252b are configured to mount onto either side of the side block spray gun 240 and each side block 252a, 252b includes a union fitting 254a, 254b. Each side block 252a, 252b also includes a manifold valve 256a, 256b associated with the respective union fitting 254a, 254b. Each manifold valve 256a, 256b may be configured to selectively open and close to either allow the respective fluid component to flow from the connected hose, such as whip hose 64a, 64b, through the respective side block 252a, 252b and into the inner mixing chamber of the side block spray gun 240 or prevent delivery of the fluid component into the inner mixing chamber of the side block spray gun 240. In this embodiment, each side block 252a, 252b further comprises a female hose coupling 255a, 255b configured to receive a corresponding male hose coupling, such as male coupling 65a, 65b shown in FIG. 5, on the end of one of the pair of whip hoses 64a, 64b.

Each side block 252a, 252b also includes a gun coupling configured to connect the respective side block 252a, 252b to the side block spray gun 240 and provide communication between each side block 252a, 252b and the inner mixing chamber of the side block spray gun 240. Gun coupling 258b on side block 252b is illustrated in FIG. 8. The corresponding gun coupling on side block 252a is not shown, but it is substantially identical to gun coupling 258b. As illustrated in FIG. 8, side blocks 252a, 252b are attached to side block spray gun 240 using one or more suitable fasteners 260, including but not limited to a conventional fastener, such as a screw or pin, or any other fastening means or method that provides an adequate connection between the side blocks 252a, 252b and the side block spray gun 240.

In some circumstances, it may be desirable to recirculate the individual fluid components through at least a portion of the system without mixing and discharging them through the spray gun. For example, circulating the fluid components may help prevent debris from clogging up hoses, ports, and couplings located throughout the spray system. Recirculating the fluid components may also help maintain or improve the quality of the fluid components by causing fillers contained within the fluid components to be re-suspended within the fluid instead of settling within the storage tanks, the proportioner, or the hoses. In addition, circulating the individual fluid components may also allow the user to preheat the fluid components before they are mixed and sprayed, which may result in an improved application. Recirculating fluid components through the system may be done as a part of the regular maintenance for the components of the spray system in order to maintain or improve the performance and lifespan of the various components.

As described above, some spray systems, such as spray system 10 shown in FIG. 2, include circulation lines 24a, 24b between the storage tanks 20a, 20b and the proportioner 30 that allow the user to recirculate fluid components from the storage tanks 20a, 20b, through the proportioner 30 and back into the storage tanks 20a, 20b. While helpful to an extent, this limited recirculation does not provide the same benefits as recirculating the fluid components through the entire system. Specifically, when the recirculation is limited to the circuit between the storage tanks 20a, 20b and the proportioner 30, any fluid components located in the system components downstream of the proportioner (e.g., heated hose 60, whip hoses 64a, 64b, and spray gun manifold 50) are not recirculated. As a result, any such fluid components are not preheated, the fillers are not re-suspended in those fluid components, and debris is not removed from the system components and the associated couplings and ports.

In some systems, heated hose 60 may comprise about 400 or more feet of hose, so there can be a substantial amount of fluid components located within the heated hose 60. Therefore, it may be beneficial to recirculate the fluid components throughout the entire spray system. One way to recirculate the fluid components throughout the entire spray system is to use a recirculation block. In its simplest form, a recirculation block may include an entry port (or set of entry ports) configured to connect to spray gun manifold 50 to receive fluid components and an exit port (or set of exit ports) configured to connect to one or more return hoses that lead back to storage tanks 20a, 20b, such as circulation lines 24a, 24b.

FIG. 9 depicts spray system 310, which is identical to spray system 10 of FIG. 1, except that spray gun 40 has been replaced with a recirculation block 300. Incorporating recirculation block 300 into spray system 310 results in a complete circuit that allows the user to recirculate the fluid components through the entire spray system 310. In the illustrated embodiment, the fluid components flow from storage tanks 20a, 20b to proportioner 30 through proportioner supply lines 22a, 22b. After passing through proportioner 30, the fluid components then flow to spray gun manifold 50 via heated hose 60, fluid temperature sensor 66 and whip hoses 64a, 64b. Finally, the fluid components flow from spray gun manifold 50, through recirculation block 300 and return to storage tanks 20a, 20b via circulation lines 24a, 24b, thereby completing the circuit. The arrows in FIG. 9 indicate the direction of the flow of fluid components through spray system 310.

FIG. 10 depicts an example of a prior art recirculation block 400, such as a Part 15B853 Circulation Manifold made by Graco Inc., which is part of a 246362 Circulation Manifold Kit also made by Graco Inc. Recirculation block 400 is configured to be used in conjunction with a junction block spray gun and a corresponding spray gun manifold comprising a single junction block, such as junction block spray gun 140 and junction block spray gun manifold 150 shown in FIGS. 4 and 5 and described above. In the illustrated embodiment, recirculation block 400 only includes a single pair of entry ports 402a, 402b that are configured to connect with a spray gun manifold comprising a single junction block, such as junction block spray gun manifold 150. Specifically, as shown, entry ports 402a, 402b are configured to connect to gun couplings 158a, 158b of junction block spray gun manifold 150 to allow fluid components to flow from whip hoses 64a, 64b through junction block spray gun manifold 150 and into recirculation block 400. As shown in FIG. 10, recirculation block 400 further comprises a pair of exit ports that are configured to connect with a pair of return hoses, such as circulation lines 24a, 24b. By way of example only, the return hoses may lead back to the tank of origin, such as storage tanks 20a, 20b, or to an independent tank for separate storage. Recirculation block 400 also includes a plurality of mounting apertures 401 that are configured to allow recirculation block 400 to be attached to a mounting surface or structure. Mounting apertures 401 are not in fluid communication with entry ports 402a, 402b or the pair of exit ports.

It will be appreciated that recirculation block 400 is not configured to be used in conjunction with a side block spray gun and a corresponding spray gun manifold comprising a pair of side blocks, such as side block spray gun 240 and side block spray gun manifold 250. Accordingly, it may be beneficial to provide a single recirculation block that is configured to be used with both a junction block spray gun and a side block spray gun and their respective spray gun manifolds.

While a variety of recirculation blocks have been made and used, it is believed that no one prior to the inventor(s) has made or used an invention as described herein.

### BRIEF DESCRIPTION OF THE DRAWINGS

It is believed the present invention will be better understood from the following description of certain examples taken in conjunction with the accompanying drawings, in which like reference numerals identify the same elements and in which:

FIG. 1 depicts a block diagram of an exemplary prior art spray system that includes circulation lines;

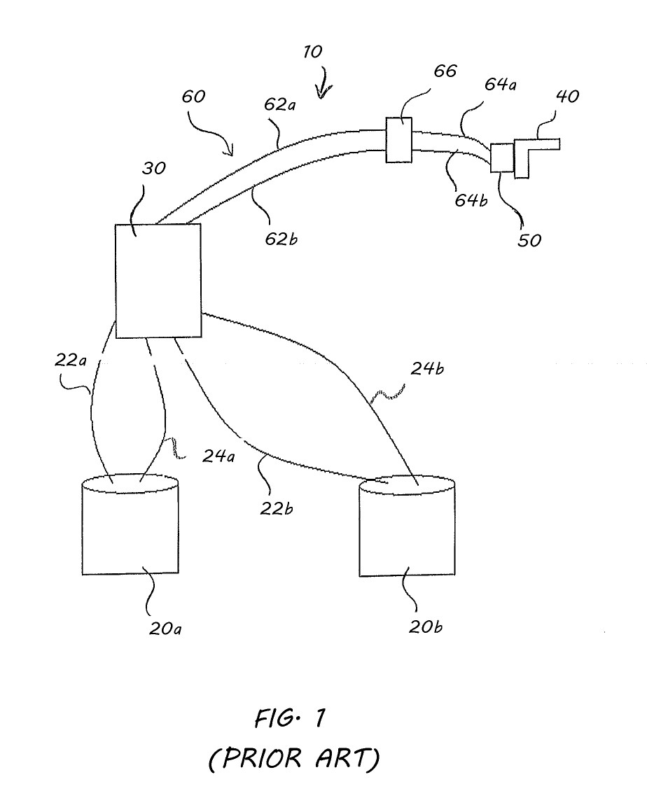

FIG. 2 depicts a perspective view of the spray system of FIG. 1;

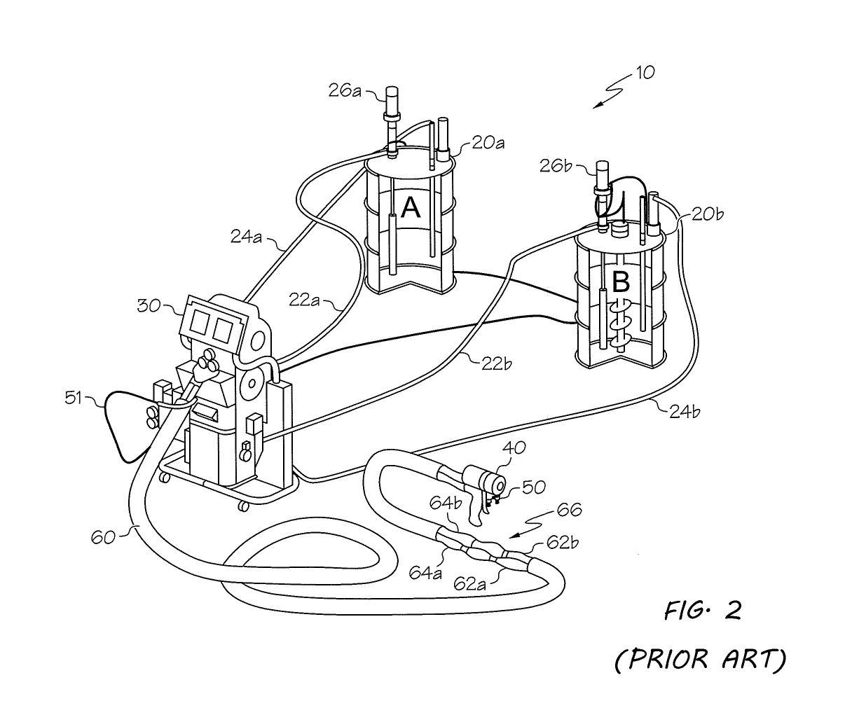

FIG. 3 depicts a perspective view of an exemplary prior art spray system similar to the system in FIGS. 1 and 2, but without circulation lines;

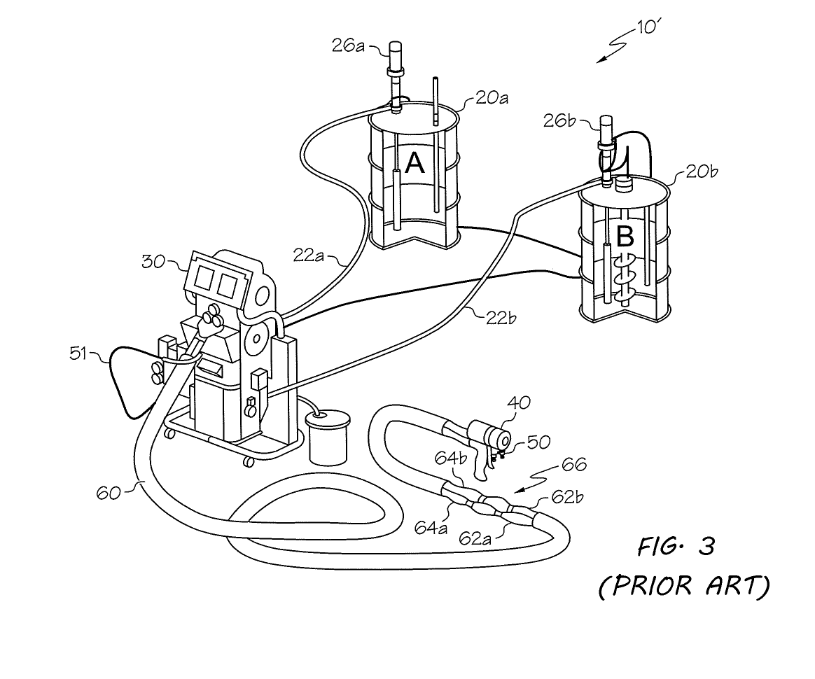

FIG. 4 depicts a front perspective view of an exemplary prior art junction block spray gun and an exemplary prior art junction block spray gun manifold;

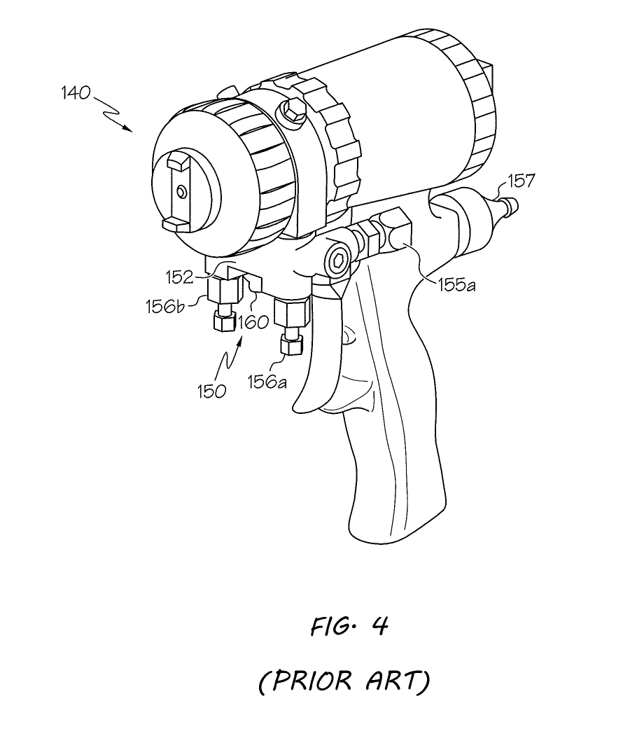

FIG. 5 depicts a front perspective view of the exemplary junction block spray gun manifold of FIG. 4;

FIG. 6 depicts a front perspective view of an exemplary prior art side block spray gun and an exemplary prior art side block spray gun manifold;

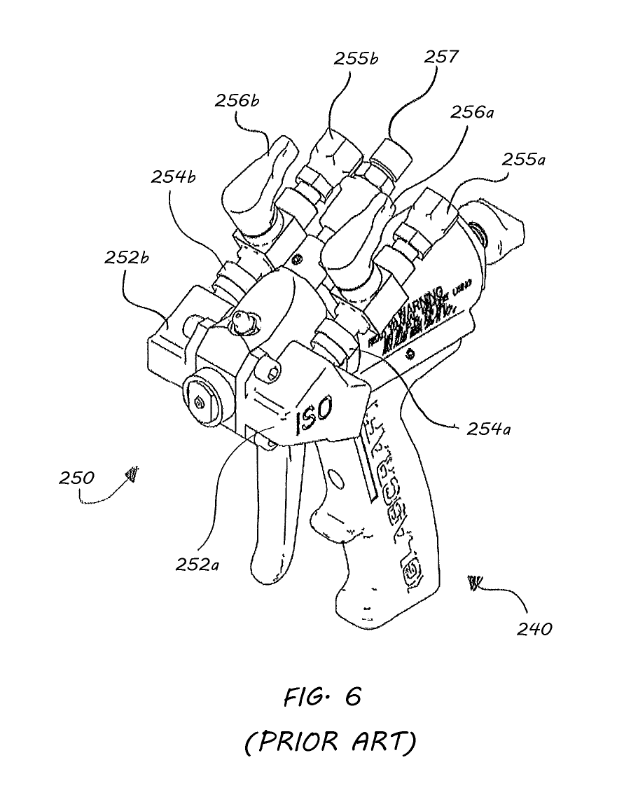

FIG. 7 depicts a rear perspective view of the side block spray gun and side block spray gun manifold of FIG. 6;

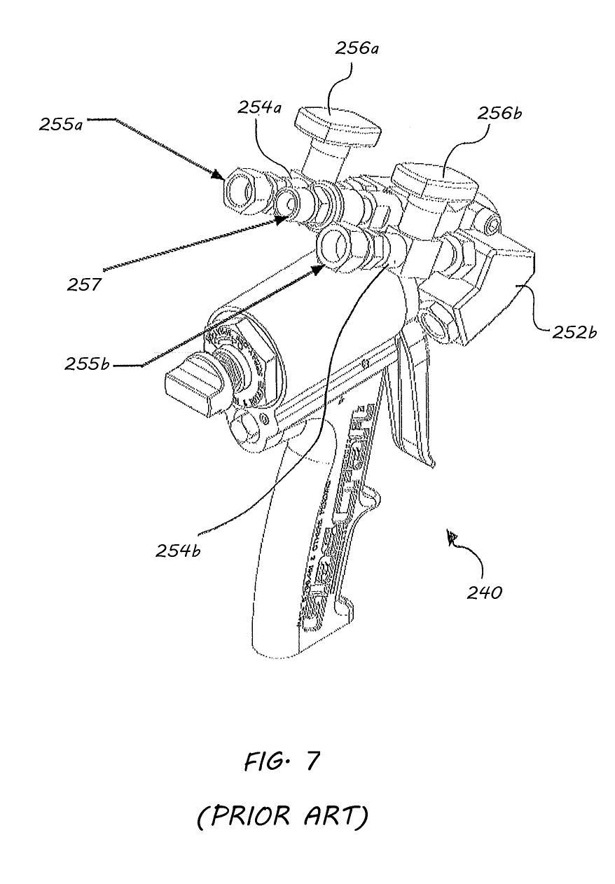

FIG. 8 depicts an exploded assembly view of the side block spray gun and side block spray gun manifold of FIG. 6;

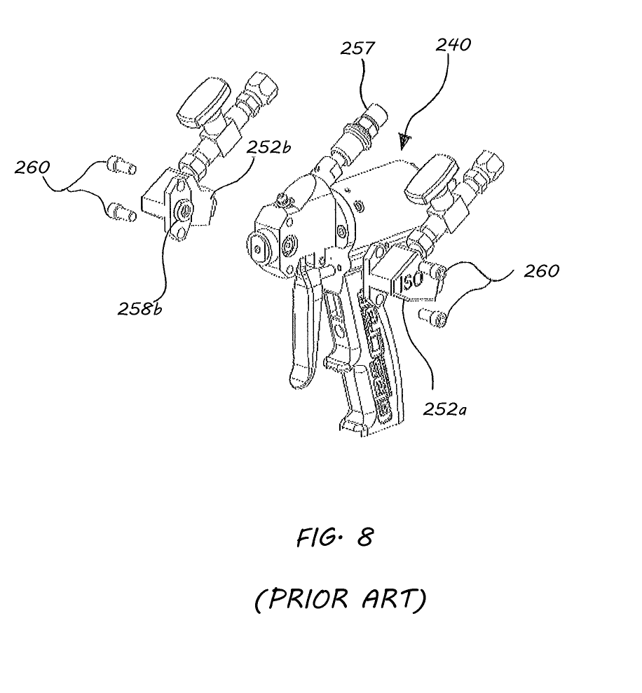

FIG. 9 depicts a block diagram of an exemplary spray system where the spray gun has been replaced with a recirculation block;

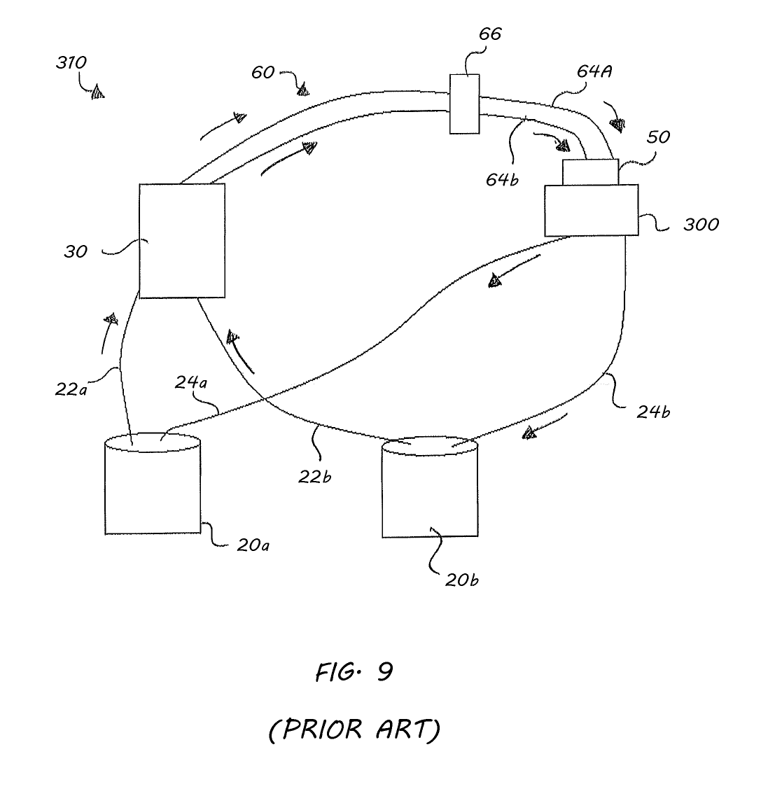

FIG. 10 depicts a front perspective view of an exemplary prior art recirculation block configured to be used in conjunction with the junction block spray gun manifold of FIG. 4;

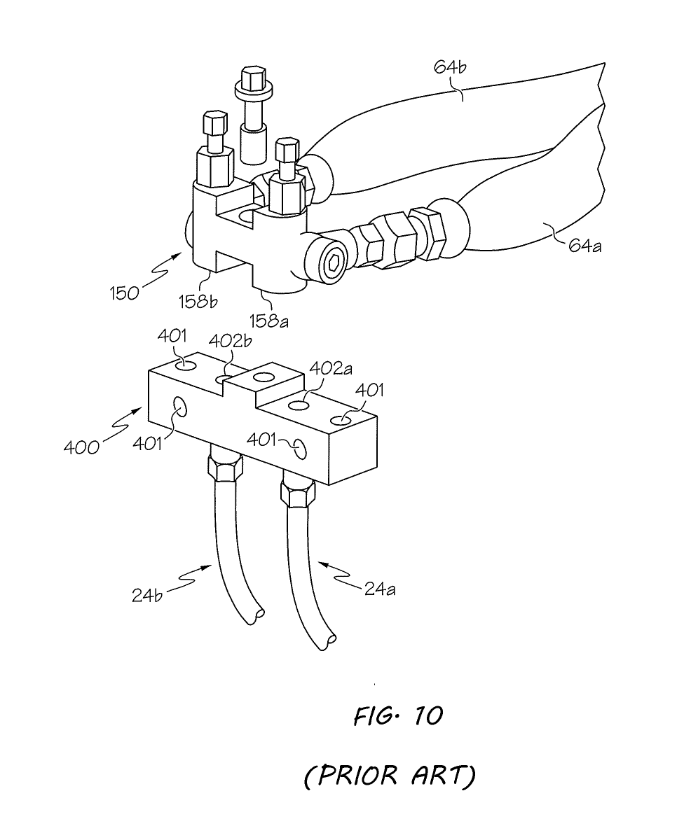

FIG. 11 depicts a front perspective view of an exemplary recirculation block;

FIG. 12 depicts a rear perspective view of the recirculation block of FIG. 11;

FIG. 13 depicts a bottom plan view of the recirculation block of FIG. 11;

FIG. 14 depicts a side cross-sectional view of the recirculation block of FIG. 11 taken along line A-A in FIG. 13;

FIG. 15 depicts a top cross-sectional view of the recirculation block of FIG. 11 taken along line B-B in FIG. 14;

FIG. 16 depicts a rear perspective view of an exemplary recirculation block assembly that includes the recirculation block of FIG. 11 and a pair of exemplary return fitting assemblies;

FIG. 17 depicts an exploded assembly view of the recirculation block assembly of FIG. 16;

FIG. 18 depicts a front perspective view of the recirculation block assembly of FIG. 16 attached to a mounting structure with a piece of one of the return fitting assemblies removed;

FIG. 19 depicts a front perspective view of the recirculation block assembly of FIG. 16 with an exemplary side block spray gun manifold comprising two individual side blocks connected to the recirculation block; and

FIG. 20 depicts a front perspective view of the recirculation block assembly of FIG. 16 with an exemplary junction block spray gun manifold connected to the recirculation block.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The following description of certain examples of the invention should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

It will be appreciated that, for convenience and clarity, spatial terms such as “top” “bottom”, “front”, “rear”, “left” and “right” are used herein with respect to one exemplary method of installing a recirculation block in the field. However, recirculation blocks can be used and installed in many orientations and positions, and these terms are not intended to be limiting and absolute.

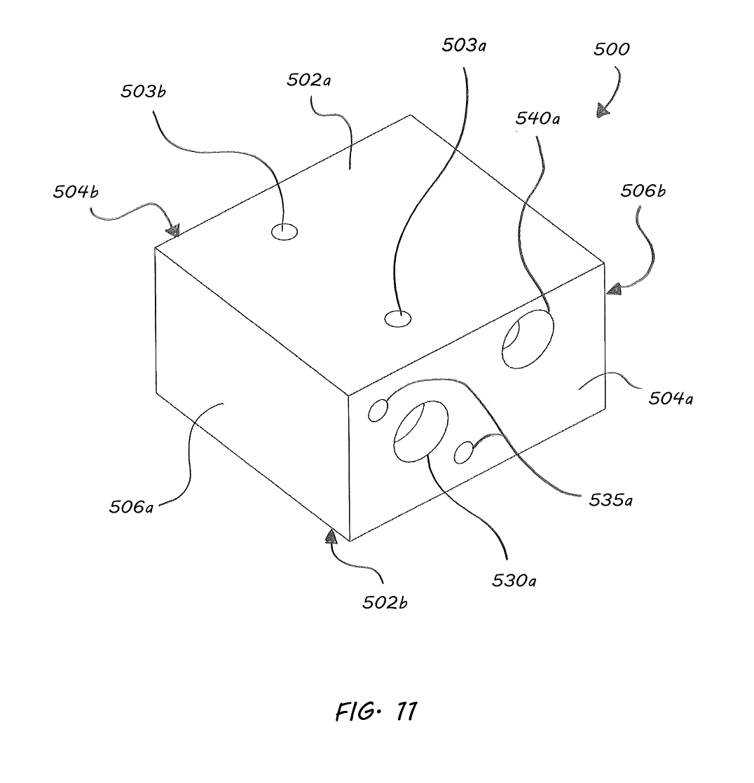

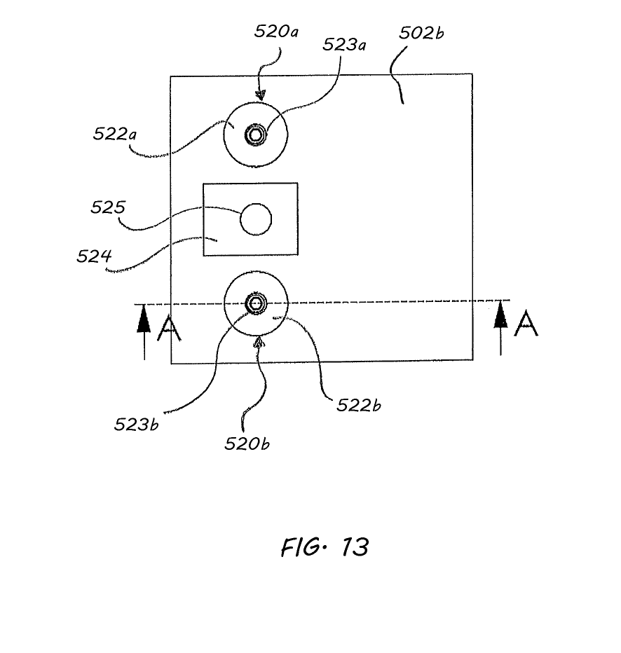

FIGS. 11-15 illustrate an exemplary recirculation block 500 that is configured to be used with both a junction block spray gun and a side block spray gun and their respective spray gun manifolds. As shown, recirculation block 500 comprises a top face 502a and a bottom face 502b that are connected by a right side face 504a, a left side face 504b, a front face 506a, and a rear face 506b. Recirculation block 500 includes a pair of lubrication apertures 503a, 503b positioned on top face 502a that are configured to receive any suitable lube fittings 513a, 513b configured to allow a user to feed a lubricant into the internal structures and components of recirculation block 500 by using a grease gun, including but not limited to zerk fittings. In addition to allowing a user to lubricate internal structures, including but not limited to port seals 522a, 522b, 532a, 532b and internal check valves 560a, 560b, lube fittings 513a, 513b may also be used to help flush out old fluid components from the internal structures of recirculation block 500.

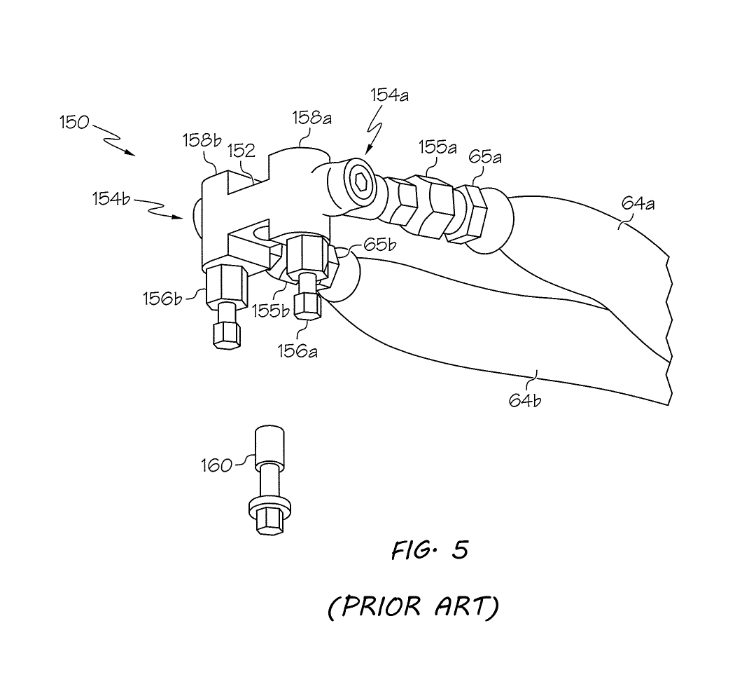

In this embodiment, recirculation block 500 also includes a pair of junction block entry ports 520a, 520b positioned on the bottom face 502b that are configured to be connected to a junction block spray gun manifold (as described below). The bottom face 502b further includes a manifold mount 524 positioned between junction block entry ports 520a, 520b that includes a fastening aperture 525. Manifold mount 524 and junction block fastening aperture 525 are configured to allow a junction block spray gun manifold, such as junction block spray gun manifold 150 described above, to be attached to recirculation block 500. Specifically, junction block fastening aperture 525 may be configured to receive any suitable fastener, including but not limited to a conventional fastener, such as the pin shown in FIG. 5.

As shown in FIGS. 11-15, recirculation block 500 further includes a pair of side block entry ports 530a, 530b positioned on the right side face 504a and left side face 504b, respectively, that are configured to be connected to a side block spray gun manifold (as described below). The right side face 504a further comprises a pair of side block fastening apertures 535a positioned obliquely relative to the central axis of side block entry port 530a. Similarly, the left side face 504b further comprises a pair of side block fastening apertures 535b positioned obliquely relative to the central axis of side block entry port 530b. Side block fastening apertures 535a, 535b are each configured to allow an individual side block, such as side block 252a, 252b described above, to be attached to recirculation block 500. Specifically, side block fastening apertures 535a, 535b may be configured to receive any suitable fastener, including but not limited to a conventional fastener, such as fasteners 260 described above. Side block fastening apertures 535a, 535b may be arranged in such a way so as to cause the side blocks 252a, 252b to be oriented at a desired angle relative to the horizontal axis of recirculation block 500 when they are attached to recirculation block 500. Having the side blocks 252a, 252b oriented at an angle relative to the horizontal axis of recirculation block 500 may prevent a tight radius from being applied to whip hoses 64a, 64b, which may reduce the stress on whip hoses 64a, 64b and reduce the risk of kinking the core of whip hoses 64a, 64b. By way of example only, side block fastening apertures may be arranged in such a way so as to cause side blocks 252a, 252b to be oriented at a 45 degree angle relative to the horizontal axis of recirculation block 500.

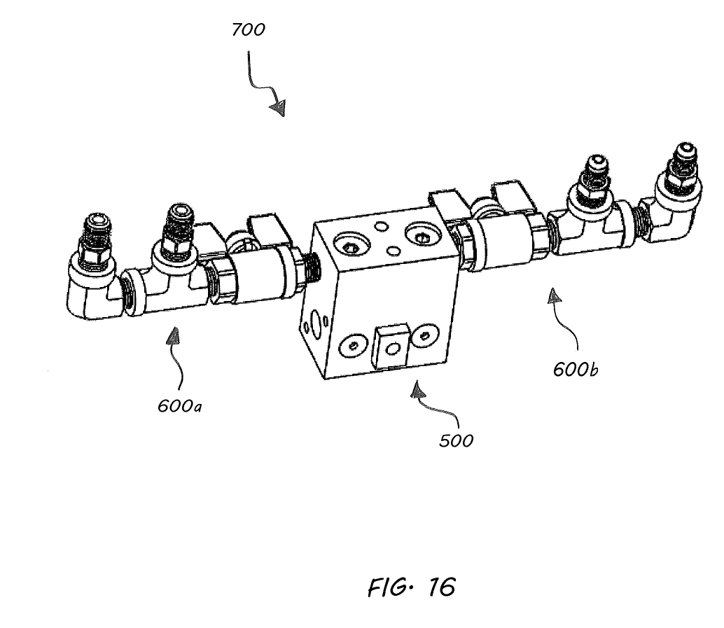

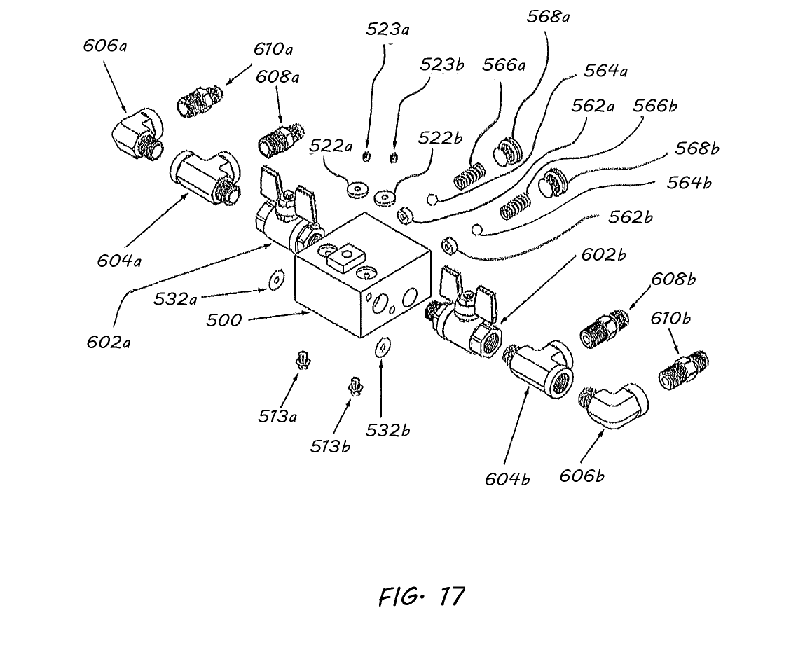

In the illustrated embodiment, recirculation block 500 also includes a pair of exit ports 540a, 540b positioned on the right side face 504a and left side face 504b, respectively. Exit ports 540a, 540b are configured to be connected to respective return fitting assembly 600a, 600b. Specifically, as shown in FIGS. 16-20, exit port 540a is connected to right side return fitting assembly 600a, and exit port 540b is connected to left side return fitting assembly 600b. Right side return fitting assembly 600a and left side return fitting assembly 600b will be described in more detail below.

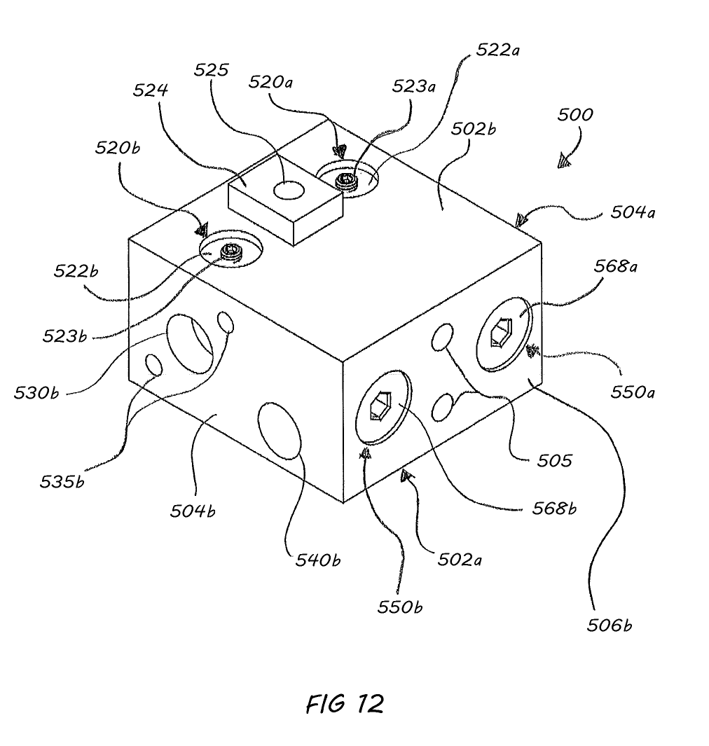

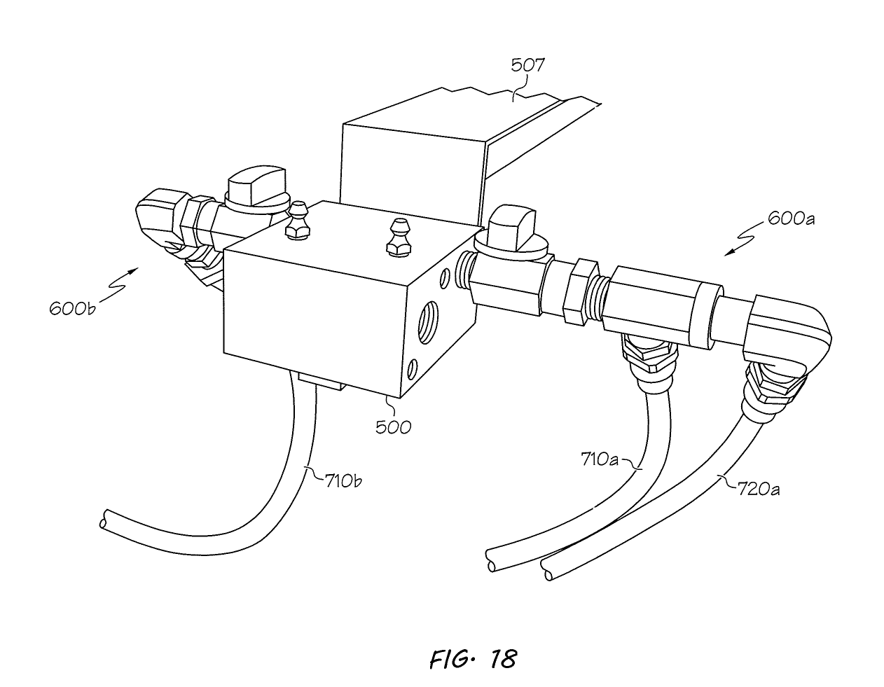

The embodiment shown in FIGS. 11-15 also includes a pair of internal check valve openings 550a, 550b in rear face 506b that are configured to house a pair of internal check valves 560a, 560b (described in more detail below). As can be seen in FIG. 12, internal check valve openings 550a, 550b are sealed by a respective internal check valve plug 568a, 568b. Furthermore, recirculation block 500 also includes a pair of block mounting apertures 505 in rear face 506b that are configured to allow recirculation block 500 to be attached to a mounting structure in a desired location. Recirculation block 500 may be attached to a mounting structure using any suitable devices or methods configured to keep recirculation block 500 secure and stable, including but not limited to conventional fasteners in conjunction with block mounting apertures 505 or other methods or devices that do not require block mounting apertures, such as adhesives. FIGS. 18-20 depict mounting structure 507 comprising a mounting arm. Mounting structure 507 may be located at any suitable location, including but not limited to within a hose rack.

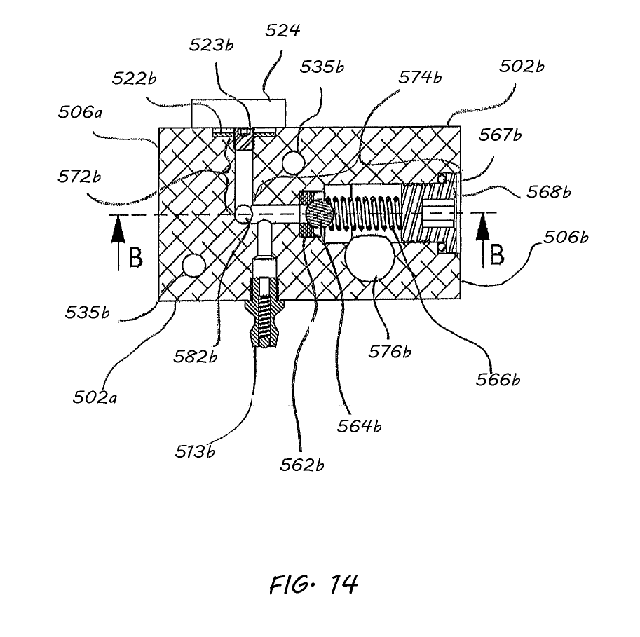

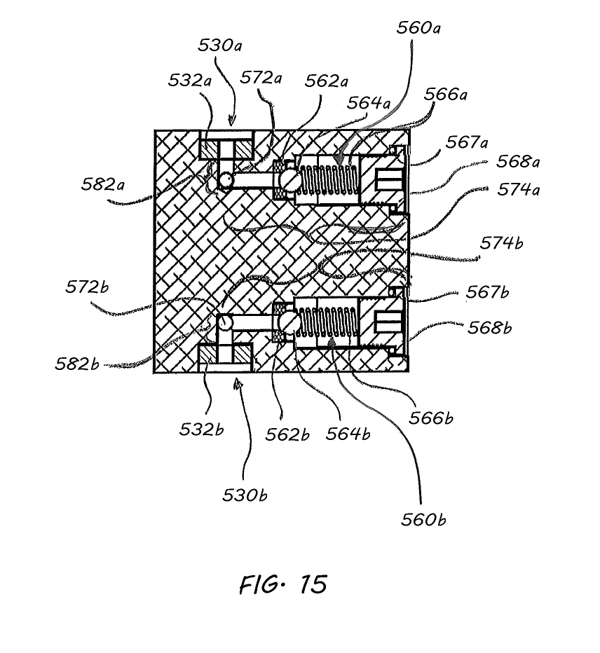

In the illustrated embodiment, each of the entry ports (junction block entry ports 520a, 520b and side block entry ports 530a, 530b) includes a port seal 522a, 522b, 532a, 532b positioned within each respective entry port 520a, 520b, 530a, 530b. Each port seal 522a, 522b, 532a, 532b may be configured to facilitate the connection of the applicable spray gun manifold to recirculation block 500 and to prevent leaks during recirculation. Port seals 522a, 522b, 532a, 532b may be soft seals, which are seals comprised of material having one or more of the following characteristics: low Shore D hardness, good elasticity, good flexibility, good chemical resistance, and good temperature stability. For example, port seals 522a, 522b, 532a, 532b may comprise material that has a Shore D hardness of about D50 or less, a tensile elongation at break of about 300% or more, and/or a maximum operating temperature of at least about 500° F. or at least about 260° C. In some embodiments, port seals 522a, 522b, 532a, 532b may comprise polytetrafluroethylene (PTFE), preferably Teflon® PTFE, and more preferably virgin Teflon® PTFE. Soft seals having one or more of the characteristics described above may provide benefits compared to traditional, hard seals or metal-on-metal seals, including providing superior sealing across a range of pressures compared to hard seals or metal-on-metal seals, particularly at lower pressures. Soft seals may also comprise material that has a low coefficient of friction to provide a slippery surface that facilitates cleaning of the seals. Port seals 522a, 522b, 532a, 532b are positioned with their respective entry ports 520a, 520b, 530a, 530b so that they provide a fluid-tight seal with the corresponding gun coupling (e.g., gun couplings 158a, 158b in junction block spray gun manifold 150 or the gun couplings on the individual side blocks 252a, 252b for side block spray gun manifold 250) when the selected spray gun manifold is connected to recirculation block 500, while still allowing the respective fluid component to flow through the selected spray gun manifold, into and through recirculation block 500. As illustrated by a comparison of FIGS. 14 and 15, in some embodiments, port seals 522a, 522b may comprise a different thickness relative to port seals 532a, 532b. In the illustrated embodiment, port seals 522a, 522b are thinner than port seals 532a, 532b due to the different forces being applied to each of those port seals 522a, 522b, 532a, 532b depending on which type of manifold is attached to the respective port seal 522a, 522b, 532a, 532b.

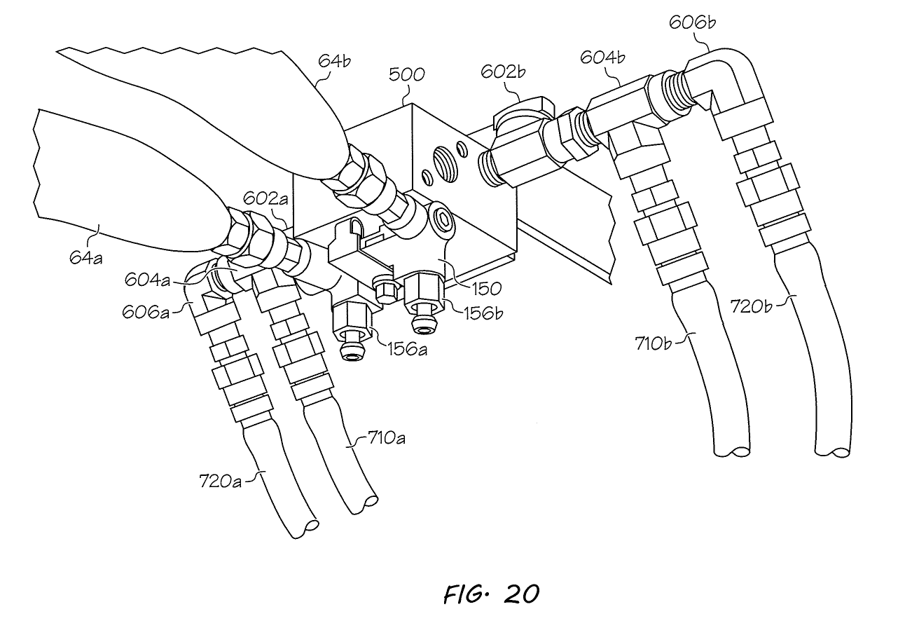

In a side block configuration, such as the one shown in FIGS. 12-16 and 19 where recirculation block 500 is configured to be connected to a side block spray gun manifold, such as individual side blocks 252a, 252b of side block spray gun manifold 250, port seals 522a, 522b positioned within junction block entry ports 520a, 520b respectively, are held in place and the central opening in each port seal 522a, 522b is sealed by a fastener, such as set screw 523a, 523b. In the side block configuration, the fasteners in the central opening in each port seal 532a, 532b are removed so that the central opening remains open to allow fluid components to flow through the side block spray gun manifold into recirculation block 500. In a junction block configuration, such as the one shown in FIG. 20 where recirculation block 500 is configured to be connected to a junction block spray gun manifold, such as junction block spray gun manifold 150, port seals 532a, 532b positioned within side block entry ports 530a, 530b respectively, are held in place and the central opening in each port seal 532a, 532b is sealed by a fastener, such as a set screw. In the junction block configuration, set screws 523a, 523b are removed so that the central opening in each port seal 522a, 522b remains open to allow fluid components to flow through the junction block spray gun manifold into recirculation block 500. As a result, a user can alternate recirculation block 500 between a side block configuration and a junction block configuration by inserting and removing the corresponding fasteners, such as threaded plugs or set screws 523a, 523b, in the appropriate port seals 522a, 522b, 532a, 532b.

As shown in FIGS. 14 and 15, recirculation block 500 includes a series of interconnected channels configured to allow fluid components to enter recirculation block 500 through an entry port 520a, 520b, 530a, 530b, flow through recirculation block 500 and exit recirculation block 500 through a corresponding exit port 540a, 540b. Specifically, in the illustrated embodiment, entry port 520b is in fluid communication with a junction block channel 572b, and junction block channel 572b is in fluid communication with an internal check valve channel 574b. As shown, internal check valve channel 574b is in fluid communication with an exit port channel 576b, which is in fluid communication with exit port 540b. Internal check valve channel 574b houses an internal check valve 560b configured to help prevent bleed back of the fluid components and to help prevent leaks associated with open ports or downstream valves being left open or failing.

As shown, internal check valve 560b comprises a seat 562b, a ball 564b, a spring 566b, and a plug 568b. In this embodiment, internal check valve 560b further comprises an o-ring 567b positioned around a portion of plug 568b to help seal internal check valve channel 574b. Seat 562b, ball 564b, spring 566b, and plug 568b are arranged longitudinally along a portion of internal check valve channel 574b. Seat 562b abuts a shoulder formed in internal check valve channel 574b and ball 564b is positioned adjacent to a central opening in seat 562b. Spring 566b is held in compression between ball 564b at a first end and a plug 568b at a second end such that ball 564b selectively seals the central opening in seat 562b. Internal check valve 560b is configured to allow a fluid component to flow at a predetermined pressure in the direction from entry port 520b or entry port 530b toward exit port 540b while also preventing a fluid component from flowing in the opposite direction regardless of the pressure. Specifically, when spring 566b is compressed, such as when a fluid component flows with enough pressure into internal check valve channel 574b from either junction block channel 572b or side block channel 582b, then ball 564b is forced away from seat 562b toward plug 568b, which allows the fluid component to flow through internal check valve channel 572b into exit port channel 576b and out exit port 540b. Accordingly, a fluid component can flow into recirculation block 500 via entry port 520b, flow through junction block channel 572b into internal check valve channel 574b and exit recirculation block 500 through exit port 540b via exit port channel 576b.

In some embodiments, seats 562a, 562b may comprise silicone having a high Shore A hardness. For example, the silicone may comprise a Shore A hardness of at least A70. Such a material may provide an improved seal over a wide range of chemicals and viscosities as compared to conventional metal seats or seals.

Entry port 520a is in fluid communication with a separate junction block channel 572a that is substantially identical to junction block channel 572b. In other words, entry port 520a and its associated junction block channel 572a are essentially a mirror image of entry port 522a and junction block channel 572b. Similarly, internal check valve channel 574a is in fluid communication with an exit port channel that is in fluid communication with exit port 540a. The exit port channel that is in fluid communication with exit port 540a is substantially identical to exit port channel 576b. In other words, internal check valve channel 574a and its associated exit port channel are essentially a mirror image of internal check valve channel 574b and exit port channel 576b. The only differences are that the junction block channel 572a connected to entry port 520a is in fluid communication with internal check valve channel 574a shown in FIG. 15 (instead of being in fluid communication with internal check valve channel 574b), which in turn is in fluid communication with the exit port channel that is in fluid communication with exit port 540a (instead of being in fluid communication with exit port channel 576b). As a result, a fluid component can flow into recirculation block 500 via entry port 520a, flow through the connected junction block channel 572a into internal check valve channel 574a, and exit recirculation block 500 through exit port 540a via an exit port channel between internal check valve channel 574a and exit port 540a.

As can be seen in FIG. 15, entry port 530a is in fluid communication with a side block channel 582a, and side block channel 582a is in fluid communication with an internal check valve channel 574a. As discussed above, internal check valve channel 574a is in fluid communication with an exit port channel (not shown) which is in fluid communication with exit port 540a. Internal check valve channel 574a houses an internal check valve 560a that is substantially identical to internal check valve 560b described above. As shown, internal check valve 560a comprises a seat 562a, a ball 564a, a spring 566a, a plug 568a, and an o-ring 567a positioned around a portion of plug 568a to help seal internal check valve channel 574a. These components of internal check valve 560a are arranged and function substantially identically to those of internal check valve 560b described above, and, for that reason, the description of the arrangement and function of those components will not be repeated. Accordingly, a fluid component can flow into recirculation block 500 via entry port 530a, flow through side block channel 582a into internal check valve channel 574a and exit recirculation block 500 through exit port 540a via an exit port channel between internal check valve channel 574a and exit port 540a.

Similar to entry port 530a described above, entry port 530b is also in fluid communication with a side block channel 582b, and side block channel 582b is in fluid communication with internal check valve channel 574b, which is described above. The description of internal check valve channel 574b and internal check valve 560b will not be repeated. Accordingly, a fluid component can flow into recirculation block 500 via entry port 530b, flow through side block channel 582b into internal check valve channel 574b and exit recirculation block 500 through exit port 540b via exit port channel 576b.

As a result of the series of interconnected channels within recirculation block 500, a fluid component that enters recirculation block 500 through either entry port 520a or 530a is fed through internal check valve channel 574a and exits recirculation block 500 through exit port 540a. Alternatively, a fluid component that enters recirculation block 500 through either entry port 520b or 530b is fed through internal check valve channel 574b and exits recirculation block 500 through exit port 540b. Accordingly, the exit ports 540a, 540b and the corresponding return fitting assemblies 600a, 600b do not need to be manipulated or altered by the user based on which type of spray gun manifold is connected to recirculation block 500.

FIGS. 16-20 illustrate a recirculation block assembly 700 comprising recirculation block 500 and return fitting assemblies 600a, 600b. In this embodiment, return fitting assembly 600a is connected to recirculation block 500 via exit port 540a in such a way so as to allow fluid components to flow through recirculation block 500 into return fitting assembly 600a. Similarly, return fitting assembly 600b is connected to recirculation block 500 via exit port 540b in such a way as to allow fluid components to flow through recirculation block 500 into return fitting assembly 600b.

As shown in FIGS. 16-17 and 19-20, return fitting assembly 600a includes an external check valve 602a, a tee fitting 604a, and an elbow fitting 606a. Return fitting assembly 600a also includes a first circulation line connector 608a engaged with tee fitting 604a and a second circulation line connector 610a engaged with elbow fitting 606a. First circulation line connector 608a and second circulation line connector 610a are each configured to allow a circulation line to be connected to return fitting assembly 600a to complete the recirculation circuit and return the fluid component to the appropriate storage tank. Similarly, as shown in FIGS. 16-17 and 19-20, return fitting assembly 600b includes an external check valve 602b, a tee fitting 604b, and an elbow fitting 606b. Return fitting assembly 600b also includes a first circulation line connector 608b engaged with tee fitting 604b and a second circulation line connector 610b engaged with elbow fitting 606b. First circulation line connector 608b and second circulation line connector 610b are each configured to allow a circulation line to be connected to return fitting assembly 600b to complete the recirculation circuit and return the fluid component to the appropriate storage tank.

The inclusion of both tee fitting 604a, 604b and elbow fitting 606a, 606b in each return fitting assembly 600a, 600b allows for two circulation lines to be connected to each return fitting assembly 600a, 600b. It will be appreciated that, in other embodiments, additional tee fittings may be added in order to allow for the connection of additional circulation lines. Alternatively, in other embodiments, tee fittings 604a, 604b may be omitted entirely, and elbow fittings 606a, 606b may be connected directly to a respective external check valve 602a, 602b, resulting in a single circulation line being connected to each return fitting assembly 600a, 600b. Although return fitting assemblies 600a, 600b are substantially identical to each other in the embodiment shown in FIGS. 16-17 and 19-20, it will be appreciated that this is not required. In other embodiments, one return fitting assembly 600a, 600b may include a tee fitting 604a, 604b while the other return fitting assembly 600a, 600b does not include a tee fitting 604a, 604b. By way of example only, FIG. 18 depicts an embodiment where one return fitting assembly includes a tee fitting and an elbow fitting, which allows for two circulation lines to connected, while the other return fitting assembly does not include a tee fitting, which allows for one circulation line to be connected. Accordingly, the particular number of circulation lines connected to the return fitting assemblies 600a, 600b may vary depending on the specific requirements of a particular application.

In this embodiment, external check valves 602a, 602b are configured to selectively allow or prevent fluid components to flow from recirculation block 500 through the respective return fitting assembly 600a, 600b into connected circulation lines, such as circulation lines 710a, 710b shown in FIGS. 18, 19 and 20. In one embodiment external check valves 602a, 602b comprise butterfly valves configured to be selectively opened and closed via manual operation of a valve handle 603a, 603b. In the illustrated embodiment, external check valves 602a, 602b provide a component capable of controlling the flow of fluid components in addition to, but separate from, internal check valves 560a, 560b. External check valves 602a, 602b may comprise positive shutoff valves that are configured to provide positive closure of their respective return fitting assembly 600a, 600b to prevent fluid from flowing from recirculation block 500 through the respective return fitting assembly 600a, 600b. External check valves 602a, 602b may comprise any suitable type of shutoff valve, including but not limited to manually actuated, power-actuated or spring-actuated shutoff valves. Use of a manually actuated, power-actuated, or spring-actuated positive shutoff valve for external check valves 602a, 602b may reduce the risk of a leak by providing a positive and verifiable closure of the respective return fitting assembly 600a, 600b.

FIG. 18 depicts an embodiment wherein recirculation block 500 is attached to a mounting structure 507 without having a spray gun manifold connected to recirculation block 500. As shown in FIG. 18, return fitting assembly 600a includes external check valve 602a, tee fitting 604a, and elbow fitting 606a, and return fitting assembly 600b includes external check valve 602b and elbow fitting 606b. Circulation lines 710a, 720a are connected to tee fitting 604a and elbow fitting 606a respectively in the illustrated embodiment. In addition, in this embodiment, circulation line 710b is connected to elbow fitting 606b. At least one circulation line connected to return fitting assembly 600a (e.g., circulation line 710a) is in fluid communication with a storage tank, such as storage tanks 20a, 20b, so that the fluid component returns to the appropriate storage tank after being circulated through recirculation block 500. In some embodiments at least one circulation line connected to return fitting assembly 600a (e.g., circulation line 720a) may be in fluid communication with a proportioner, such as proportioner 30, instead of being directly connected to a storage tank. In addition, in the embodiment shown in FIG. 18, circulation line 710b is connected to return fitting assembly 600b via elbow fitting 606b. Circulation line 710b is also in fluid communication with the appropriate storage tank, such as storage tanks 20a, 20b.

In the embodiment shown in FIG. 18, a fluid component may flow from the proportioner, such as proportioner 30, through circulation line 720a into return fitting assembly 600a. If the fluid component is also being circulated through recirculation block 500 and external check valve 602a is open, then the fluid component being circulated through recirculation block 500 and the fluid component flowing from the proportioner through circulation line 720a will both flow into tee fitting 604a and subsequently exit tee fitting 604a by flowing into circulation line 710a. Alternatively, if the fluid component is not being circulated through recirculation block 500 and external check valve 602a is closed, then the fluid component may flow from the proportioner through circulation line 720a into tee fitting 604a and subsequently exit tee fitting 604a by flowing into circulation line 710a.

In some embodiments, one or both of circulation lines 710a, 710b may be in fluid communication with an auxiliary tee fitting (not shown) located at the proportioner, such as proportioner 30, and the auxiliary tee fitting may be in communication with a first auxiliary circulation line that is in communication with the proportioner and a second auxiliary circulation line that is in communication with an appropriate storage tank, such as storage tanks 20a, 20b. Use of such an auxiliary tee fitting allows a first portion of the fluid component flowing through the respective circulation line 710a, 710b to be delivered to the proportioner and a second portion of the fluid component flowing through the respective circulation line 710a, 710b to be delivered back to the appropriate storage tank.

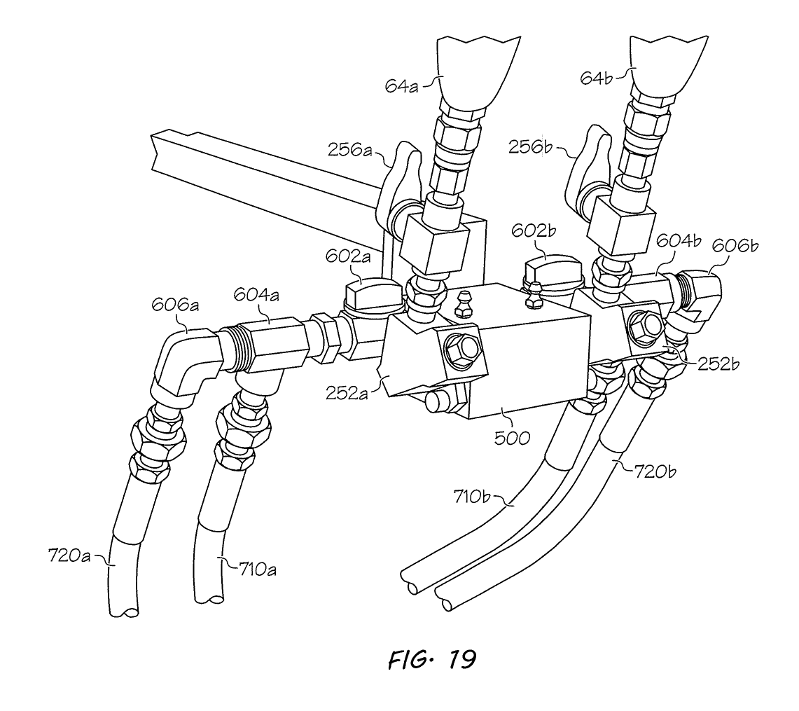

FIG. 19 depicts an embodiment where recirculation block 500 is being used in conjunction with a side block spray gun manifold, such as side block spray gun manifold 250. As shown, individual side blocks 252a, 252b are connected to recirculation block 500 via side block entry ports 530a, 530b, respectively. In this configuration, junction block entry ports 520a, 520b may be sealed by placing a fastener, such as set screw 523a, 523b, in the central opening of port seals 522a, 522b positioned within junction block entry ports 520a, 520b, respectively. In addition, whip hoses 64a, 64b are connected to side blocks 252a, 252b, respectively, as described above. Furthermore, in this embodiment, return fitting assemblies 600a, 600b are also connected to recirculation block 500. Return fitting assembly 600a includes external check valve 602a, tee fitting 604a, and elbow fitting 606a, and return fitting assembly 600b includes external check valve 602b, tee fitting 604b, and elbow fitting 606b.

In addition, as shown in FIG. 19, circulation lines 710a, 710b are connected to tee fittings 604a, 604b, respectively, and circulation lines 720a, 720b are connected to elbow fittings 606a, 606b, respectively. At least one circulation line connected to return fitting assembly 600a (e.g., circulation line 710a) is in fluid communication with a storage tank, such as storage tanks 20a, 20b, so that the fluid component provided through whip hose 64a can be returned to its respective storage tank after being recirculated. Similarly, at least one circulation line connected to return fitting assembly 600b (e.g., circulation line 710b) is in fluid communication with a storage tank, such as storage tanks 20a, 20b, so that the fluid component provided through whip hose 64b can be returned to its respective storage tank after being recirculated. In order to allow the fluid components to flow from the respective whip hose 64a, 64b, through recirculation block 500 and into the circulation lines 710a, 710b both the manifold valves 256a, 256b and the external check valves 602a, 602b should be manipulated to an open position (i.e., the position where they allow the fluid components to flow through those particular components). If the user wants to stop the recirculation process, then either or both of the manifold valves 256a, 256b and the external check valves 602a, 602b can be manipulated to a closed position (i.e., the position where they prevent the fluid components from flowing through those particular valves).

As discussed above with respect to FIG. 18, circulation lines 720a, 720b shown in FIG. 19 may be used to facilitate recirculation of a fluid component. Specifically, in the embodiment shown in FIG. 19, a fluid component may flow from the proportioner, such as proportioner 30, through circulation line 720a, 720b into a respective return fitting assembly 600a, 600b. If the fluid component is also being circulated through recirculation block 500 and the respective external check valve 602a, 602b is open, then the fluid component being circulated through recirculation block 500 and the fluid component flowing from the proportioner through circulation line 720a, 720b will both flow into the respective tee fitting 604a, 604b and subsequently exit the respective tee fitting 604a, 604b by flowing into the respective circulation line 710a, 710b. Alternatively, if the fluid component is not being circulated through recirculation block 500 and the respective external check valve 602a, 602b is closed, then the fluid component may flow from the proportioner through circulation line 720a, 720b into the respective tee fitting 604a, 604b and subsequently exit the respective tee fitting 604a, 604b by flowing into the respective circulation line 710a, 710b.

In addition, as also discussed above with respect to FIG. 18, in some embodiments one or both of circulation lines 710a, 710b shown in FIG. 19 may be in fluid communication with an auxiliary tee fitting (not shown) located at the proportioner, such as proportioner 30. The auxiliary tee fitting may be in communication with a first auxiliary circulation line that is in communication with the proportioner and a second auxiliary circulation line that is in communication with an appropriate storage tank, such as storage tanks 20a, 20b. Use of such an auxiliary tee fitting allows a first portion of the fluid component flowing through the respective circulation line 710a, 710b to be delivered to the proportioner and a second portion of the fluid component flowing through the respective circulation line 710a, 710b to be delivered back to the appropriate storage tank.

FIG. 20 depicts an embodiment where recirculation block 500 is being used in conjunction with a junction block spray gun manifold, such as side block spray gun manifold 150. As shown, junction block 150 is connected to recirculation block 500 via junction block entry ports 520a, 520b, respectively. In this configuration, side block entry ports 530a, 530b may be sealed by placing a fastener, such as a set screw, in the central opening of port seals 532a, 532b positioned within side block entry ports 530a, 530b, respectively. In addition, whip hoses 64a, 64b are connected to junction block 150, as described above.

Furthermore, in this embodiment, return fitting assemblies 600a, 600b are also connected to recirculation block 500. Return fitting assembly 600a includes external check valve 602a, tee fitting 604a, and elbow fitting 606a, while return fitting assembly 600b includes external check valve 602b, tee fitting 604b, and elbow fitting 606b. In addition, as shown in FIG. 20, circulation lines 710a, 710b are connected to tee fittings 604a, 604b, respectively, and circulation lines 720a, 720b are connected to elbow fittings 606a, 606b, respectively. At least one circulation line connected to return fitting assembly 600a (e.g., circulation line 710a) is in fluid communication with a storage tank, such as storage tanks 20a, 20b, so that the fluid component provided through whip hose 64a can be returned to its respective storage tank after being recirculated. Similarly, at least one circulation line connected to return fitting assembly 600b (e.g., circulation line 710b) is in fluid communication with a storage tank, such as storage tanks 20a, 20b, so that the fluid component provided through whip hose 64b can be returned to its respective storage tank after being recirculated. In order to allow the fluid components to flow from the respective whip hose 64a, 64b, through recirculation block 500 and into the circulation lines 710a, 710b, both the manifold valves 156a, 156b and the external check valves 602a, 602b should be manipulated to an open position. If the user wants to stop the recirculation process, then either or both of the manifold valves 156a, 156b and the external check valves 602a, 602b can be manipulated to a closed position.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of any claims that may be presented and is understood not to be limited to the details of structure and operation shown and described in the specification and drawings.

What is claimed is:

1. A recirculation block comprising
a first junction block entry port and a second junction block entry port;
a first side block entry port and a second side block entry port; and
a first exit port and a second exit port, wherein the first exit port is in fluid communication with both the first junction block entry port and the first side block entry port, and wherein the second exit port is in fluid communication with both the second junction block entry port and the second side block entry port.

2. The recirculation block of claim 1, further comprising a manifold mount positioned adjacent to the first junction block entry port, wherein the manifold mount is selectively couplable with a spray gun manifold.

3. The recirculation block of claim 1, wherein the first junction block entry port and the second junction block entry port are defined by a first face of the recirculation block, wherein the first side block entry port is defined by a second face of the recirculation block, and wherein the second side block entry port is defined by a third face of the recirculation block.

4. The recirculation block of claim 3, further comprising a first pair of block fastening apertures defined by the second face and a second pair of block fastening apertures defined by the third face, wherein the first pair of block fastening apertures is selectively couplable with a first side block and the second pair of block fastening apertures is selectively couplable with a second side block.

5. The recirculation block of claim 4, wherein the first pair of block fastening apertures are positioned obliquely relative to a central axis of the first side block entry port, wherein the second pair of block fastening apertures are positioned obliquely relative to a central axis of the second side block entry port.

6. The recirculation block of claim 1, further comprising a face defining at least one lubrication aperture.

7. The recirculation block of claim 6, further comprising at least one zerk fitting inserted within the at least one lubrication aperture.

8. The recirculation block of claim 1, wherein the first junction block entry port, the second junction block entry port, the first side block entry port, and the second side block entry port each comprise a respective port seal positioned within the respective entry port.

9. The recirculation block of claim 8, wherein at least one of the respective port seals comprises a soft seal.

10. The recirculation block of claim 1, further comprising a pair of fasteners selectively couplable with each side block entry port to selectively seal each side block entry port, wherein the fasteners are coupled with the side block entry ports when fluid is flowing through the junction block entry ports.

11. The recirculation block of claim 1, further comprising a pair of fasteners selectively couplable with each junction block entry port to selectively seal each junction block entry port, wherein the fasteners are coupled with the junction block entry ports when fluid is flowing through the side block entry ports.

12. The recirculation block of claim 1, further comprising a first internal check valve and a second internal check valve, wherein the first internal check valve is positioned downstream of the first junction block entry port and the first side block entry port and upstream of the first exit port, and wherein the second internal check valve is positioned downstream of the second junction block entry port and the second side block entry port and upstream of the second exit port.

13. The recirculation block of claim 12, wherein the first internal check valve comprises:
a seat, wherein the seat comprises a central opening;
a ball positioned adjacent to the central opening of the seat;
a plug; and
a spring held in compression between the ball at a first end and the plug at a second end such that the ball selectively seals the central opening of the seat.

14. The recirculation block of claim 13, wherein the seat comprises silicone.

15. A recirculation block comprising
a top face and a bottom face that are connected by a right side face, a left side face, a front face, and a rear face;
a first junction block entry port and a second junction block entry port, wherein the first junction block entry port and the second junction block entry port are defined by the bottom face;
a first side block entry port and a second side block entry port, wherein the first side block entry port is defined by the right side face, and the second side block entry port is defined by the left side face; and
a first exit port and a second exit port, wherein the first exit port is in fluid communication with both the first junction block entry port and the first side block entry port, and wherein the second exit port is in fluid communication with both the second junction block entry port and the second side block entry port.

16. The recirculation block of claim 15, further comprising a first internal check valve and a second internal check valve, wherein the first internal check valve is positioned within a first channel that is in fluid communication with the first junction block entry port and the first side block entry port, wherein the second internal check valve is positioned within a second channel that is in fluid communication with the second junction block entry port and the second side block entry port.

17. A recirculation block for recirculating fluid within a spray system, the recirculation block comprising:
a first junction block entry port;
a first side block entry port;
a first exit port;
a first internal check valve; and
a first series of interconnected channels comprising a first junction block entry channel in fluid communication with the first junction block entry port, a first side block entry channel in fluid communication with the first side block entry port, an internal check valve channel in fluid communication with both the first junction block entry channel and the first side block entry channel, and an exit port channel in fluid communication with both the internal check valve channel and the first exit port; and
wherein the first internal check valve is positioned within the internal check valve channel to selectively allow fluid to flow from either the first junction block entry port or the first side block entry port to the first exit port.

18. The recirculation block of claim 17, further comprising a face defining a first lubrication aperture in fluid communication with the first series of interconnected channels.

19. The recirculation block of claim 18, further comprising a first lube fitting positioned within the first lubrication aperture.

20. The recirculation block of claim 17, further comprising:
a second junction block entry port;
a second side block entry port;
a second exit port;
a second internal check valve; and
a second series of interconnected channels comprising a second junction block entry channel in fluid communication with the second junction block entry port, a second side block entry channel in fluid communication with the second side block entry port, a second internal check valve channel in fluid communication with both the second junction block entry channel and the second side block entry channel, and a second exit port channel in fluid communication with both the second internal check valve channel and the second exit port; and
wherein the second internal check valve is positioned within the second internal check valve channel to selectively allow fluid to flow from either the second junction block entry port or the second side block entry port to the second exit port.
